(19) United States
(12) Patent Application Publication
(10) Pub. No.: US 2021/0067033 A1
(43) Pub. Date: Mar. 4, 2021

(54) DIFFERENTIAL SENSING AND MAINTENANCE OF FLYING CAPACITOR VOLTAGE IN A SWITCHED-MODE POWER SUPPLY CIRCUIT

(71) Applicant: QUALCOMM Incorporated, San Diego, CA (US)

(72) Inventors: Yue JING, San Jose, CA (US); Sanghwa JUNG, Los Gatos, CA (US)

(21) Appl. No.: 17/006,001

(22) Filed: Aug. 28, 2020

Related U.S. Application Data
(60) Provisional application No. 62/941,694, filed on Nov. 27, 2019.
(60) Provisional application No. 62/893,676, filed on Aug. 29, 2019.

(51) Int. Cl. H02M 3/07

(52) U.S. Cl. CPC H02M 3/07

(57) ABSTRACT

Techniques and apparatus for sensing and/or maintaining a differential voltage across a flying capacitor in a switched-mode power supply circuit (SMPS) when operating in certain modes (e.g., full duty mode). One example power supply circuit generally includes a first transistor, a second transistor coupled to the first transistor via a first node, a third transistor coupled to the second transistor via a second node, a fourth transistor coupled to the third transistor via a third node, a first capacitive element having a first terminal coupled to the first node and having a second terminal coupled to the third node, and a voltage control circuit coupled to the first capacitive element and configured to maintain a defined voltage across the first capacitive element. The power supply circuit may further include a switched-capacitor circuit coupled to the first capacitive element and configured to sense a differential voltage across the first capacitive element.

### CROSS-REFERENCE TO RELATED APPLICATIONS

This application claims benefit of U.S. Provisional Patent Application Ser. No. 62/893,676, entitled “Full Duty Mode Multi-level Buck Converter with Voltage Balancing of Capacitors” and filed Aug. 29, 2019, and the benefit of U.S. Provisional Patent Application Ser. No. 62/941,694, entitled “Differential Sensing of Flying Capacitor Voltage in a Switched-Mode Power Supply Circuit” and filed Nov. 27, 2019, both of which are herein incorporated by reference in their entireties.

### TECHNICAL FIELD

Certain aspects of the present disclosure generally relate to electronic circuits and, more particularly, to methods and apparatus for differential sensing of and/or maintaining a voltage across a flying capacitor in a switched-mode power supply circuit.

### BACKGROUND

A voltage regulator ideally provides a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example. A switching regulator may be implemented, for example, by a switched-mode power supply (SMPS), such as a buck converter, a boost converter, a buck-boost converter, or a charge pump.

For example, a buck converter is a type of SMPS that may include: (1) a high-side switch coupled between a relatively higher voltage rail and a switching node, (2) a low-side switch coupled between the switching node and a relatively lower voltage rail, (3) and an inductor coupled between the switching node and a load (e.g., represented by a shunt capacitive element). The high-side and low-side switches are typically implemented with transistors, although the low-side switch may alternatively be implemented with a diode.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure generally relate to methods and apparatus for differential sensing of a voltage across a flying capacitor in a switched-mode power supply (SMPS) circuit, such as a three-level buck converter, divide-by-two (Div2) charge pump, or an adaptive combination power supply circuit capable of switching between a three-level buck converter and a Div2 charge pump.

Certain aspects of the present disclosure generally relate to methods and apparatus for maintaining the flying capacitor voltage in an SMPS circuit (e.g., during full duty mode).

Certain aspects of the present disclosure provide a switched-mode power supply circuit. The switched-mode power supply circuit generally includes a plurality of transistors, a first capacitive element coupled to the plurality of transistors, and a switched-capacitor circuit coupled to the first capacitive element and configured to sense a differential voltage across the first capacitive element.

Certain aspects of the present disclosure provide a power supply circuit. The power supply circuit generally includes a first transistor; a second transistor coupled to the first transistor via a first node; a third transistor coupled to the second transistor via a second node; a fourth transistor coupled to the third transistor via a third node; a first capacitive element having a first terminal coupled to the first node and having a second terminal coupled to the third node; and a switched-capacitor circuit coupled to the first capacitive element and configured to sense a differential voltage across the first capacitive element.

Certain aspects of the present disclosure are directed to a switched-mode power supply circuit. The switched-mode power supply circuit generally includes a plurality of switching devices coupled in series, a first capacitive element having a first terminal coupled to a first node coupling a first pair of the plurality of switching devices and having a second terminal coupled to a second node coupling a second pair of the plurality of switching devices, and a voltage control circuit coupled to the first capacitive element and configured to maintain a defined voltage across the first capacitive element. For certain aspects, the switched-mode power supply circuit further includes a switched-capacitor circuit coupled to the first capacitive element and configured to sense a differential voltage across the first capacitive element.

Certain aspects of the present disclosure are directed to a power supply circuit. The power supply circuit generally includes a first transistor, a second transistor coupled to the first transistor via a first node, a third transistor coupled to the second transistor via a second node, a fourth transistor coupled to the third transistor via a third node, a first capacitive element having a first terminal coupled to the first node and having a second terminal coupled to the third node, and a voltage control circuit coupled to the first capacitive element and configured to maintain a defined voltage across the first capacitive element. For certain aspects, the power supply circuit further includes a switched-capacitor circuit coupled to the first capacitive element and configured to sense a differential voltage across the first capacitive element.

Certain aspects of the present disclosure are directed to a power supply circuit. The power supply circuit generally includes a three-level buck converter circuit having a plurality of transistors coupled between a power supply rail and a reference potential node, having an inductive element coupled between the plurality of transistors and a load, and having a capacitive element coupled to the plurality of transistors. The power supply circuit also includes a voltage control circuit coupled to the capacitive element and configured to maintain a defined voltage across the capacitive element.

Certain aspects of the present disclosure provide a power management integrated circuit (PMIC) comprising at least a portion of a switched-mode power supply circuit described herein.

Certain aspects of the present disclosure provide a battery charging circuit comprising a switched-mode power supply circuit described herein.

Certain aspects of the present disclosure provide a method of regulating power. The method generally includes operating a switched-mode power supply circuit comprising a plurality of transistors and a first capacitive element coupled to the plurality of transistors and sensing a differential voltage across the first capacitive element using a switched-capacitor circuit.

Certain aspects of the present disclosure provide a method of regulating power. The method generally includes operating a switched-mode power supply circuit comprising a plurality of switching devices coupled in series and a first capacitive element and maintaining a defined voltage across the first capacitive element with a voltage control circuit coupled to the first capacitive element. The first capacitive element has a first terminal coupled to a first node coupling a first pair of the plurality of switching devices and has a second terminal coupled to a second node coupling a second pair of the plurality of switching devices.

Certain aspects of the present disclosure provide a method of regulating power. The method involves operating a power supply circuit comprising a first transistor, a second transistor coupled to the first transistor via a first node, a third transistor coupled to the second transistor via a second node, a fourth transistor coupled to the third transistor via a third node, and a first capacitive element having a first terminal coupled to the first node and having a second terminal coupled to the third node. The method also entails maintaining a defined voltage across the first capacitive element with a voltage control circuit coupled to the first capacitive element.

Certain aspects of the present disclosure provide an apparatus for regulating power. The apparatus generally includes means for operating a switched-mode power supply circuit comprising a plurality of switching devices coupled in series and a first capacitive element and means for maintaining a defined voltage across the first capacitive element. The first capacitive element has a first terminal coupled to a first node coupling a first pair of the plurality of switching devices and has a second terminal coupled to a second node coupling a second pair of the plurality of switching devices.

Certain aspects of the present disclosure are directed to an apparatus for generating an output voltage across a load. The apparatus generally includes first, second, third, and fourth switching devices coupled in series between a first power rail and a second power rail, wherein the first power rail is configured to receive an input voltage; a first capacitor coupled between a first node between the first and second switching devices, and a second node between the third and fourth switching devices; an inductor coupled between a third node between the second and third switching devices and the load; a controller configured to operate the first, second, third, and fourth switching devices to generate the output voltage across the load; and a voltage control circuit configured to maintain a defined voltage across the first capacitor.

Certain aspects of the present disclosure provide a method for generating an output voltage across a load. The method generally includes turning on first and second switching devices and turning off third and fourth switching devices to generate the output voltage to be substantially the same as an input voltage applied to a first power rail, wherein the first, second, third, and fourth switching devices are coupled in series between the first power rail and a second power rail, and wherein an inductor is coupled between a first node between the second and third switching devices and the load; and controlling a voltage across a first capacitor coupled between a second node between the first and second switching devices, and a third node between the third and fourth switching devices.

Certain aspects of the present disclosure are directed to an apparatus for generating an output voltage across a load. The apparatus generally includes means for turning on first and second switching devices and turning off third and fourth switching devices to generate the output voltage to be substantially the same as an input voltage applied to a first power rail, wherein the first, second, third, and fourth switching devices are coupled in series between the first power rail and a second power rail, wherein an inductor is coupled between a first node between the second and third switching devices and the load; and means for controlling a voltage across a first capacitor coupled between a second node between the first and second switching devices, and a third node between the third and fourth switching devices.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device comprising a power management integrated circuit (PMIC) that includes a switched-mode power supply circuit with a flying capacitive element and a circuit for sensing a differential voltage across the flying capacitive element, in accordance with certain aspects of the present disclosure.

FIG. 2 is a block diagram of an example adaptive combination power supply circuit, in accordance with certain aspects of the present disclosure.

FIG. 3 is a schematic diagram of an example switched-capacitor circuit for differential sensing of a flying capacitor, in accordance with certain aspects of the present disclosure.

FIG. 4A is a graph of example waveforms for sensing a differential voltage across a flying capacitor in a switched-mode power supply (SMPS) circuit when the SMPS circuit is in continuous conduction mode (CCM) with more than 50% duty cycle, in accordance with certain aspects of the present disclosure.

FIG. 4B is a graph of example waveforms for sensing the differential voltage across the flying capacitor when the SMPS circuit is in skip mode, in accordance with certain aspects of the present disclosure.

FIG. 5 is a flow diagram of example operations for regulating power using a switched-capacitor circuit, in accordance with certain aspects of the present disclosure.

FIG. 6 is a schematic diagram of an example three-level buck converter in full duty mode.

FIG. 7 is a schematic diagram of the example buck converter of FIG. 6 and a voltage control circuit, in accordance with certain aspects of the present disclosure.

FIG. 8A is a schematic diagram of the example buck converter of FIG. 7 and an implementation of the voltage control circuit with a comparator and bang-bang control current sources, in accordance with certain aspects of the present disclosure.

FIG. 8B is a timing diagram of full duty mode operation for the circuits in FIG. 8A, in accordance with certain aspects of the present disclosure.

FIG. 8C is a schematic diagram of the example buck converter of FIG. 7 and an implementation of the voltage control circuit with two comparators and bang-bang control current sources, in accordance with certain aspects of the present disclosure.

FIG. 9 is a schematic diagram of an example multiple-branch three-level buck converter with a voltage control circuit, in accordance with certain aspects of the present disclosure.

FIG. 10 is a flow diagram of example operations for regulating power using a voltage control circuit, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for differential sensing of a flying capacitor in a switched-mode power supply (SMPS) circuit—such as a three-level buck converter, a divide-by-two (Div2) charge pump, or an adaptive combination power supply circuit capable of switching therebetween—in any operational mode. Other aspects of the present disclosure provide techniques and apparatus for maintaining the flying capacitor voltage in an SMPS circuit during full duty mode, to provide a seamless transition and avoid damaging components when changing operational modes from the full duty mode to a switching mode.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in many apparatuses, such as in the power supply, battery charging circuit, or power management circuit of a communication system, a video codec, audio equipment such as music players and microphones, a television, camera equipment, and test equipment such as an oscilloscope.

Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

Power management integrated circuits (power management ICs or PMICs) are used for managing the power requirement of a host system and may include and/or control one or more voltage regulators (e.g., buck converters or charge pumps). A PMIC may be used in battery-operated devices, such as mobile phones, tablets, laptops, wearables, etc., to control the flow and direction of electrical power in the devices. The PMIC may perform a variety of functions for the device such as DC-to-DC conversion, battery charging, power-source selection, voltage scaling, power sequencing, etc.

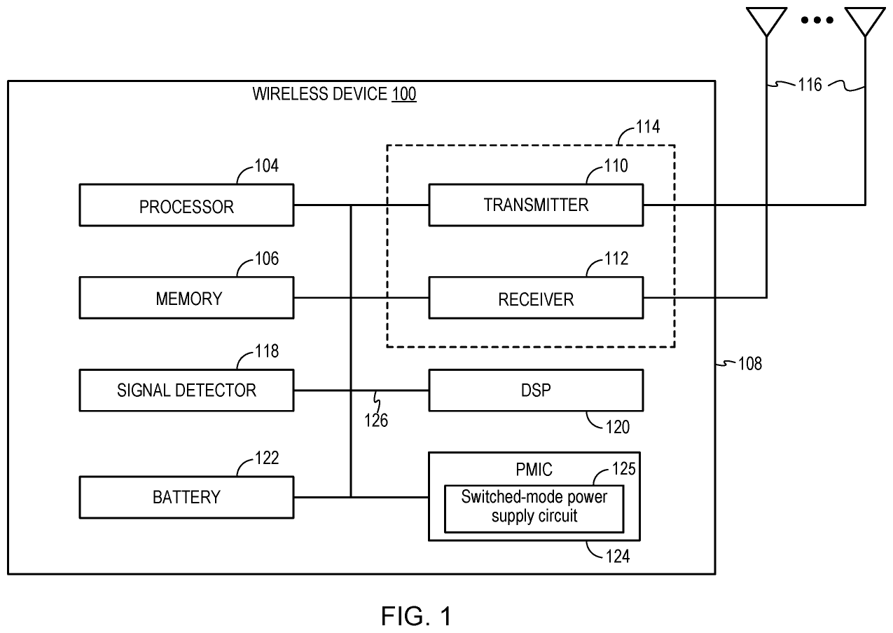

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, a wearable device, etc.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

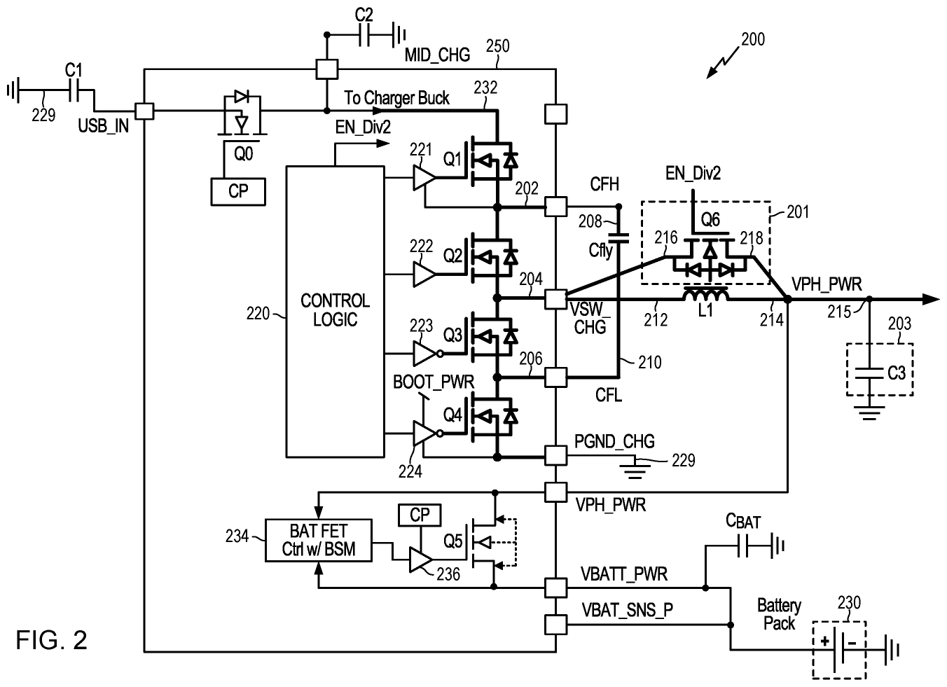

The device 100 may further include a battery 122 used to power the various components of the device 100. The device 100 may also include a power management integrated circuit (power management IC or PMIC) 124 for managing the power from the battery to the various components of the device 100. The PMIC 124 may perform a variety of functions for the device such as DC-to-DC conversion, battery charging, power-source selection, voltage scaling, power sequencing, etc. In certain aspects, the PMIC 124 may include at least a portion of a switched-mode power supply circuit 125. The switched-mode power supply circuit 125 may be implemented by any of various suitable switched-mode power supply circuit topologies, such as a three-level buck converter, a divide-by-two (Div2) charge pump, or an adaptive combination power supply circuit, such as by the adaptive combination power supply circuit 200 of FIG. 2, which can switch between operating as a three-level buck converter and a Div2 charge pump.

The various components of the device 100 may be coupled together by a bus system 126, which may include a power bus, a control signal bus, and/or a status signal bus in addition to a data bus.

### Example Adaptive Combination Charging Architecture

In order to charge the battery in a portable device (e.g., a smartphone, tablet, and the like), a battery charging circuit may be utilized. For certain aspects, the battery charging circuit, or at least a portion thereof, may reside in a power management integrated circuit (PMIC) in the device. The battery charging circuit may comprise two or more parallel charging circuits, each capable of charging the battery, which may be connected together and to the battery in an effort to provide fast charging of the battery. The parallel charging circuits may be configured so that these circuits do not adversely interfere with each other during battery charging (e.g., in a master-slave relationship).

Battery charging systems are trending towards higher charging current, which leads to the desire for higher efficiency converters that can operate over a wider battery voltage range. To reduce thermal issues and/or conserve power, it may be desirable to operate such battery charging systems with higher efficiency.

In one example parallel charging solution, the master charger is implemented based on a buck converter topology. The master charger is capable of charging the battery and providing power by itself or may be paralleled with one or more slave chargers. Each of the slave chargers may be implemented as a switched-capacitor converter (e.g., a divide-by-two (Div2) charge pump) or a switched-mode power supply (SMPS) topology using an inductor (e.g., a buck converter).

With certain inductor-based two-level buck converters, it may be challenging to use a smaller inductance L. A lower switching frequency (Fsw) may be utilized in an effort to lower switching loss. However, lower switching frequency may cause higher voltage ripple with lower inductance L, which leads to more inductor loss. A smaller inductance may also create a thermal hot spot. It may also be difficult to further enhance efficiency with certain two-level buck converters. The loss, especially the switching loss, will be even higher under higher input voltage (Vᵢₙ). Furthermore, it may be hard to further increase power density due to limitations of power loss, inductor size, etc.

Accordingly, some power supply solutions may be implemented by a charger architecture for further enhancing charging efficiency, especially under heavy load. Referred to herein as an “adaptive combination power supply circuit,” this charger architecture further increases power density to reduce the solution size and use a smaller inductor, balances power loss, avoids a thermal hot spot, supports a higher power specification with existing adaptor cables, and/or operates in the highest efficiency range in different scenarios.

FIG. 2 is a block diagram of an example adaptive combination power supply circuit 200 implemented as a master charging circuit, in accordance with certain aspects of the present disclosure. A three-level buck converter topology may include a first transistor Q1, a second transistor Q2, a third transistor Q3, a fourth transistor Q4, a flying capacitive element Cfly, an inductive element L1, and a load 203, which is represented here by capacitive element C3. The adaptive combination power supply circuit 200 may be realized by adding a switch 201 across the inductive element L1 of the three-level buck converter topology.

Transistor Q2 may be coupled to transistor Q1 via a first node 202, transistor Q3 may be coupled to transistor Q2 via a second node 204, and transistor Q4 may be coupled to transistor Q3 via a third node 206. For certain aspects, the transistors Q1-Q4 may be implemented as n-type metal-oxide-semiconductor (NMOS) transistors, as illustrated in FIG. 2. In this case, the drain of transistor Q2 may be coupled to the source of transistor Q1, the drain of transistor Q3 may be coupled to the source of transistor Q2, and the drain of transistor Q4 may be coupled to the source of transistor Q3. The source of transistor Q4 may be coupled to a reference potential node 229 (e.g., electric ground, labeled “PGND_CHG”) for the circuit. The flying capacitive element Cfly may have a first terminal 208 coupled to the first node 202 (labeled “CFH”) and a second terminal 210 coupled to the third node 206 (labeled “CFL”). The inductive element L1 may have a first terminal 212 coupled to the second node 204 (also referred to as the “switching node”) and a second terminal 214 coupled to the output voltage node 215 (labeled “VPH_PWR”) and the load 203.

The switch 201 may be coupled in parallel with the inductive element L1, the switch 201 having a first terminal 216 coupled to the first terminal 212 of the inductive element L1 and having a second terminal 218 coupled to the second terminal 214 of the inductive element L1. For certain aspects, the switch 201 may be implemented by a transistor, such as transistor Q6, which may be an NMOS transistor, as shown. In this case, the source of transistor Q6 may be coupled to the first terminal 212 of the inductive element L1, and the drain of transistor Q6 may be coupled to the second terminal 214 of the inductive element L1.

Control logic 220 may control operation of the adaptive combination power supply circuit 200. For example, the control logic 220 may control operation of transistors Q1-Q4 via output signals to the inputs of respective gate drivers 221-224. The outputs of the gate drivers 221-224 are coupled to respective gates of transistors Q1-Q4. During operation of the adaptive combination power supply circuit 200, the control logic 220 may cycle through four different phases, which may differ depending on whether the duty cycle is less than 50% or greater than 50%.

Operation of the adaptive combination power supply circuit 200 with a duty cycle of less than 50% is described first. In a first phase (referred to as a “charging phase”), transistors Q1 and Q3 are activated, and transistors Q2 and Q4 are deactivated, to charge the flying capacitive element Cfly and to energize the inductive element L1. In a second phase (called a “holding phase”), transistor Q1 is deactivated, and transistor Q4 is activated, such that the switching node (second node 204) is coupled to the reference potential node (e.g., PGND_CHG), the flying capacitive element Cfly is disconnected (e.g., one of the Cfly terminals is floating), and the inductive element L1 is deenergized. In a third phase (referred to as a “discharging phase”), transistors Q2 and Q4 are activated, and transistor Q3 is deactivated, to discharge the flying capacitive element Cfly and to energize the inductive element L1. In a fourth phase (also referred to as a “holding phase”), transistor Q3 is activated, and transistor Q2 is deactivated, such that the flying capacitive element Cfly is disconnected and the inductive element L1 is deenergized.

Operation of the adaptive combination power supply circuit 200 with a duty cycle greater than 50% is similar in the first and third phases, with the same transistor configurations. However, in the second phase (called a “holding phase”) following the first phase, transistor Q3 is deactivated, and transistor Q2 is activated, such that the switching node (second node 204) is coupled to the input voltage node (e.g., USB_IN or MID_CHG), the flying capacitive element Cfly is disconnected, and the inductive element L1 is energized. Similarly in the fourth phase (also referred to as a “holding phase”), transistor Q1 is activated, and transistor Q4 is deactivated, such that the flying capacitive element Cfly is disconnected and the inductive element L1 is energized.

Furthermore, the control logic 220 has an output signal labeled “EN_Div2” configured to control operation of the switch 201 and selectively enable divide-by-two charge pump operation. For certain aspects, when the EN_Div2 signal is logic low, the switch 201 is open, and the adaptive combination power supply circuit 200 operates as a three-level buck converter using the inductive element L1. When the EN_Div2 signal is logic high, the switch 201 is closed, thereby shorting across the inductive element L1 and effectively removing the inductive element L1 from the circuit, such that the power supply circuit 200 operates as a divide-by-two charge pump. The control logic 220 may be configured to automatically control operation of the switch 201 (e.g., through the logic level of the EN_Div2 signal) based on at least one of an input voltage (e.g., USB_IN from a Universal Serial Bus (USB) power source) or an operation mode, for the power supply circuit 200.

The adaptive combination power supply circuit 200 may also include a capacitive element C1, a reverse current blocking transistor Q0, a capacitive element C2, a transistor Q5, a battery 230, and a battery capacitive element C_{BAT}. The reverse current blocking transistor Q0 (which may be referred to as a “front-porch field-effect transistor (FPFET)”) may be coupled between the input voltage node (USB_IN) and the drain of transistor Q1 at node 232 (labeled “MID_CHG”). The capacitive element C1 may be coupled in shunt between the input voltage node USB_IN and the reference potential node 229, and the capacitive element C2 may be coupled in shunt between node 232 and the reference potential node 229. The reverse current blocking transistor Q0 may be implemented as an NMOS transistor, where the source of transistor Q0 is coupled to the input voltage node USB_IN and the drain of transistor Q0 is coupled to node 232. Transistor Q5 may be referred to as a battery field-effect transistor (BATFET), which may be implemented by an NMOS transistor as depicted. The drain of transistor Q5 may be coupled to the output voltage node 215 (VPH_PWR), and the source of transistor Q5 may be coupled to a terminal (e.g., a positive terminal) of the battery (labeled “VBATT_PWR”). The gate of transistor Q5 may be controlled by battery logic 234 and a gate driver 236 as shown. The battery capacitive element C_{BAT} may be coupled in parallel with the battery 230 (in shunt between VBATT_PWR and the reference potential node 229).

For certain aspects, at least a portion of the adaptive combination power supply circuit 200 may be implemented in an integrated circuit 250. For example, as illustrated in FIG. 2, at least transistors Q0-Q5, control logic 220, gate drivers 221-224, battery logic 234, and gate driver 236 may be included in the integrated circuit 250. The capacitive elements C1, C2, C3, and C_{BAT}, the inductive element L1, and the battery 230 may be implemented outside of the integrated circuit 250. Although illustrated in FIG. 2 as being outside of the integrated circuit 250, the switch 201 may be fabricated as part of the integrated circuit 250 for certain aspects.

As described above, the adaptive combination power supply circuit may be capable of switching between performing as a three-level buck converter and as a divide-by-two charge pump, by opening or closing a switch connected in parallel with the inductor. The transition may be adaptive depending on adaptor type, cable type, charging status, protection capability (e.g., current limit), etc. With respect to charging status, the adaptive combination power supply circuit may operate as a 3-level buck converter during trickle and precharging modes, operate as a Div2 charge pump during constant current (CC) mode, and back to operating as a 3-level buck converter in constant voltage (CV) mode to finish charging. The adaptive combination power supply circuit achieves the benefits of both a 3-level buck converter and a Div2 charge pump. Its flexible architecture offers different configuration options for different customer specifications. Namely, the adaptive combination power supply circuit may be configured as a 3-level buck converter, as a Div2 charge pump, or as an adaptive combination converter capable of automatically transitioning between operating as either a 3-level buck converter or a Div2 charge pump depending on operating conditions. Thus, the adaptive combination power supply circuit can support different adaptors at the highest efficiency and can support high power delivery with high efficiency.

During a precharging condition, transistor Q6 may be deactivated (the switch 201 is open), and the master charger may be operated as a 3-level buck converter to regulate the output voltage VPH_PWR at the minimum system voltage (VSYS_min) and to support the load. During CC mode, once the input voltage (e.g., USB_IN) and VPH_PWR are in the Div2 window, Q6 may be activated (the switch 201 is closed) to short the inductor, and the master charger operates in Div2 charge pump mode, incrementing or decrementing the input voltage to regulate the charging current. Once CV mode is entered, transistor Q6 is deactivated, and the master charger may return to operating as a 3-level buck converter. Similarly, if a current-rated cable is used (e.g., cable rated for 3 A) and charging current under Div2 operation leads to an input current greater than the current rating (e.g., >3 A), transistor Q6 may be deactivated (the switch is opened), and the circuit operates as a 3-level buck converter to support higher power with high efficiency.

### Example Differential Sensing of Flying Capacitor Voltage

As described above, the adaptive combination power supply circuit (also referred to as a combo mode DC/DC converter) can operate in a 3-level buck operation mode or a Div2 charge pump operation mode to convert power from Vᵢₙ to Vₒᵤₜ (e.g., from USBIN to VPH_PWR). When the adaptive combination power supply circuit operates in 3-level buck mode, the flying capacitor voltage (V_{Cfly}) should ideally be equal to Vᵢₙ/2. When V_{Cfly} deviates from Vᵢₙ/2 too much, this condition may generate a large current that can potentially damage other circuits (such as a balancing circuit) and/or create an unbalanced inductor current, which may lead to further deviation of V_{Cfly} and eventually incorrect operation of the 3-level buck converter. Therefore, it may be desirable to sense and monitor V_{Cfly}. When V_{Cfly} deviates from Vᵢₙ/2 by a certain voltage, a fault condition may be triggered, which may, for example, turn off the switcher in order to protect components from damage.

When the 3-level buck converter operates in continuous conduction mode (CCM), discontinuous conduction mode (DCM), and full-on mode, in each clock cycle one of the high-side top Q1 FET or the low-side bottom Q4 FET will be activated. This will either connect the CFH node or the CFL node to Vᵢₙ or GND. In this scenario, V_{Cfly} may be single-ended sensed by checking the CFL or CFH node voltage, respectively. However, since CFH and CFL are switching, V_{Cfly} detection blanking may be utilized to ensure no false triggering of the fault condition.

When the 3-level buck converter operates in skip mode (also referred to as “pulse-skipping mode”), all power FETs Q1-Q4 are off, and both flying capacitor terminals are floating. Without turning on the Q1 or Q4 FET, it is difficult to sense V_{Cfly} during skip mode.

When the combo mode DC/DC converter works in Div2 mode, V_{Cfly} may be used for flying capacitor short protection.

Certain aspects of the present disclosure utilize V_{Cfly} differential sensing to solve the skip mode detection issue and eliminate the V_{Cfly} detection blanking when the flying capacitor is switching. V_{Cfly} differential sensing may be accomplished using a switched-capacitor circuit, for example.

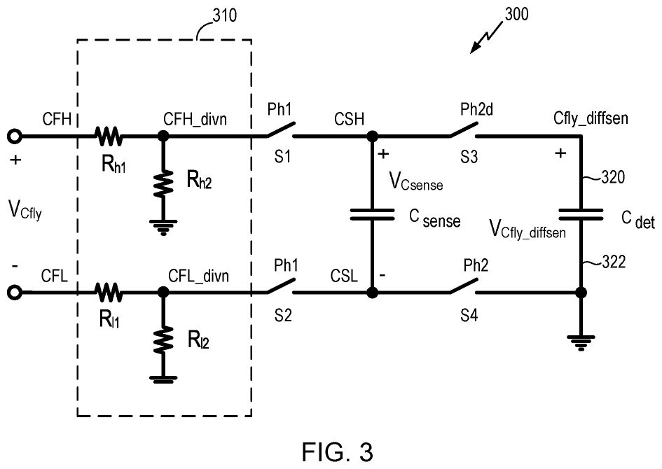

FIG. 3 is a schematic diagram of an example switched-capacitor circuit 300 for differential sensing of the flying capacitor voltage, in accordance with certain aspects of the present disclosure. The switched-capacitor circuit 300 includes (or may be considered as being coupled to) an optional voltage divider circuit 310 to reduce the sensed voltage range. The voltage divider circuit 310 may include a CFH resistor divider, which includes a series resistor Rh1 and a shunt resistor Rh2, and a CFL resistor divider, which includes a series resistor R11 and a shunt resistor R12. The divide-down ratio n may be any suitable value, such as n=5 for divide-by-five (div5). Certain aspects of the present disclosure may not utilize the voltage divider circuit, such as when the switched-capacitor circuit is used in a low-voltage system. The switched-capacitor circuit 300 also includes a sensing capacitor Cₛₑₙₛₑ, a detection capacitor C_{det}, and switches S1-S4. The switches S1-S4 may be driven by a clock signal (and/or one or more signals derived therefrom) to close and open the switches.

The sensing capacitor Cₛₑₙₛₑ may be coupled between upper sensing capacitor node CSH and lower capacitor sensing node CSL, which may be coupled to switches S1 and S2, respectively. The nodes CSH and CSL may also be selectively coupled to first and second output nodes 320, 322 of the switched-capacitor circuit 300 via switches S3 and S4, respectively. The detection capacitor C_{det} may be coupled between the first and second output nodes 320, 322.

The operation of the differential flying capacitor voltage sensing is described below. During the first clock phase Ph1, switches S1 and S2 are closed, and switches S3 and S4 are open. This state couples the CSH node to the CFH_divn node (or the CFH node) and couples the CSL node to the CFL_divn node (or the CFL node). With these connections, the voltage across Cₛₑₙₛₑ (V_{Csense}) will be charged to V_{Cfly}/n (but would be V_{Cfly} if no resistor divider is used). In this phase, no power FET is required to turn on, and V_{Csense} is not affected by the absolute voltage of the CFH or CFL node, since Cₛₑₙₛₑ senses the divided-down version of the differential voltage between the CFH and CFL nodes.

During the second clock phase Ph2, switches S1 and S2 are open, and switches S3 and S4 are closed. This state couples the CSH node to the C_{fly_diffsen} node and couples the CSL node to GND. Therefore, the voltage across C_{det} (V_{Cfly_diffsen}) will be equal to V_{Csense}. Since V_{Csense}=V_{Cfly}/n in the previous phase Ph1, V_{Cfly_diffsen}=V_{Cfly}/n. The switch S3 control signal is a rising-edge-delayed Ph2 signal (labeled “Ph2d”) compared to the switch S4 control signal. This rising-edge-delayed Ph2 signal is used to eliminate big voltage glitches on V_{Cfly_deffsen}. The falling edges of Ph2 and Ph2d may occur simultaneously. C_{det} will hold the detected C_{fly} differential voltage during Ph1. Because the flying capacitor voltage cannot change suddenly, the detected C_{fly} voltage should always be available, and no blanking is required when C_{fly} is switching.

The clock for the switches S1-S4 in the switched-capacitor circuit 300 need not be the same as the SMPS circuit clock. Rather, the clock signal may be chosen to be a multiple (e.g., 2×, 4×, etc.) of the clock for the SMPS circuit. The choice of the clock frequency for the switched-capacitor circuit 300 may depend on how frequently the C_{fly} voltage is to be checked.

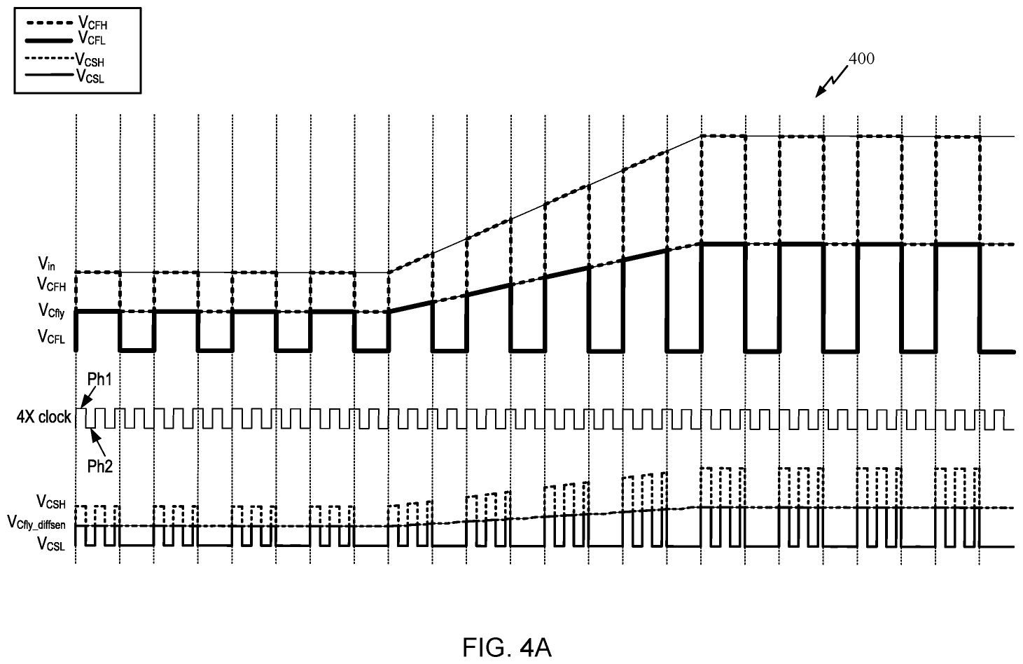

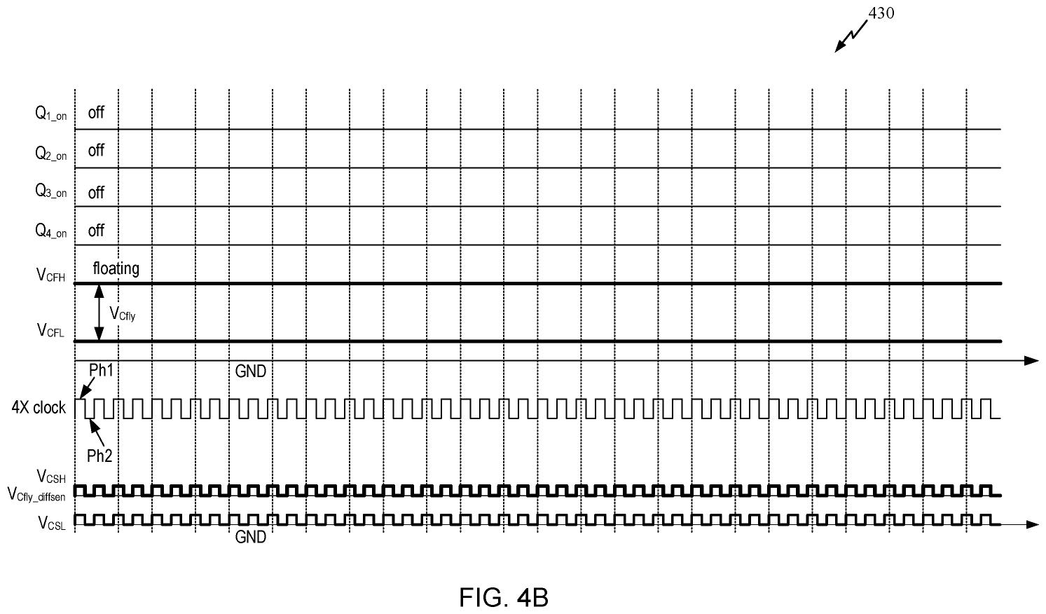

FIG. 4A is a graph 400 of example waveforms for sensing a differential voltage across a flying capacitor (e.g., C_{fly}) in an adaptive combination power supply circuit when the power supply circuit is in continuous conduction mode (CCM) with more than 50% duty cycle, in accordance with certain aspects of the present disclosure. In this example, a clock signal with 4× the frequency of the power supply circuit's switching frequency is used to control the differential sensing switches in the switched-capacitor circuit. The waveforms for CSH, CSL, and C_{fly_diffsen} are also shown. The V_{Cfly} differential sensing as described herein does not rely on any power FET being activated. Furthermore, when CFH/CFL are switching, no detection blanking is required, since the differential voltage may be continuously monitored.

FIG. 4B is a graph 430 of example waveforms for sensing the differential voltage across the flying capacitor when the adaptive combination power supply circuit is in skip mode, in accordance with certain aspects of the present disclosure. In skip mode, all the power FETs Q1, Q2, Q3 and Q4 are off, such that the CFH and CFL nodes are floating. In this scenario, it may be challenging to use single-ended sensing to sense V_{Cfly}, due to Q1 and Q4 being off. As illustrated in the example waveforms of FIG. 4B, V_{Cfly} can still be sensed during skip mode using aspects of the present disclosure, even though no power FETs are switching. In other words, the sensed differential flying capacitor voltage is available regardless of the power FETs being in an on or off condition.

### Example Operations for Power Regulation with a Switched-Capacitor Circuit

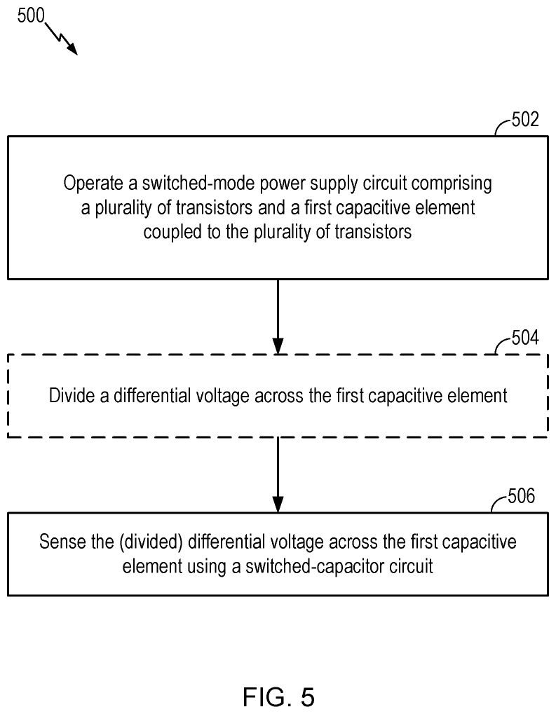

FIG. 5 is a flow diagram of example operations 500 for regulating power, in accordance with certain aspects of the present disclosure. The operations 500 may be performed by a switched-mode power supply circuit (e.g., a three-level buck converter, a Div2 charge pump, or an adaptive combination power supply circuit, such as the power supply circuit 200) and a switched-capacitor circuit, such as the switched-capacitor circuit 300. The operations 500 may be controlled by control logic, such as control logic 220.

The operations 500 may begin, at block 502, by operating the switched-mode power supply circuit. The switched-mode power supply circuit generally includes a plurality of transistors and a first capacitive element (e.g., C_{fly}) coupled to the plurality of transistors. At block 506, the switched-capacitor circuit may sense a differential voltage (e.g., V_{Cfly}) across the first capacitive element. For certain aspects, a voltage divider circuit (e.g., voltage divider circuit 310) may divide the differential voltage across the first capacitive element at block 504 before the sensing at block 506, such that the sensed voltage is a lower voltage representation of the actual differential voltage across the first capacitive element.

According to certain aspects, the plurality of transistors includes a first transistor (e.g., transistor Q1), a second transistor (e.g., transistor Q2) coupled to the first transistor via a first node (e.g., first node 202), a third transistor (e.g., transistor Q3) coupled to the second transistor via a second node (e.g., second node 204), and a fourth transistor (e.g., transistor Q4) coupled to the third transistor via a third node (e.g., third node 206), wherein the first capacitive element has a first terminal (e.g., first terminal 208) coupled to the first node and a second terminal (e.g., second terminal 210) coupled to the third node. In this case, operating the switched-mode power supply circuit at block 502 may involve: in a first phase, activating the first transistor and the third transistor and deactivating the second transistor and the fourth transistor; in a second phase, activating the third transistor and the fourth transistor and deactivating the first transistor and the second transistor; in a third phase, activating the second transistor and the fourth transistor and deactivating the first transistor and the third transistor; and in a fourth phase, activating the third transistor and the fourth transistor and deactivating the first transistor and the second transistor. In this case, the second phase may follow the first phase, the third phase may follow the second phase, and the fourth phase may follow the third phase. Furthermore, the first phase may follow the fourth phase during the operating. Such operation may occur when the duty cycle is less than 50%.

In another case, operating the switched-mode power supply circuit at block 502 may involve: in a first phase, activating the first transistor and the third transistor and deactivating the second transistor and the fourth transistor; in a second phase, activating the first transistor and the second transistor and deactivating the third transistor and the fourth transistor; in a third phase, activating the second transistor and the fourth transistor and deactivating the first transistor and the third transistor; and in a fourth phase, activating the first transistor and the second transistor and deactivating the third transistor and the fourth transistor. Such operation may occur when the duty cycle is more than 50%.

According to certain aspects, the switched-mode power supply circuit further includes an inductive element (e.g., inductive element L1) having a first terminal coupled to the second node and having a second terminal coupled to an output voltage node of the switched-mode power supply circuit.

According to certain aspects, the switched-capacitor circuit includes a second capacitive element (e.g., sensing capacitor Cₛₑₙₛₑ) having a first terminal and a second terminal; a first switch (e.g., switch S1) coupled between the first terminal of the second capacitive element and a first terminal of the first capacitive element; a second switch (e.g., switch S1) coupled between the second terminal of the second capacitive element and a second terminal of the first capacitive element; a third switch (e.g., switch S3) coupled between the first terminal of the second capacitive element and a first output node (e.g., first output node 320) of the switched-capacitor circuit; and a fourth switch (e.g., switch S4) coupled between the second terminal of the second capacitive element and a second output node (e.g., second output node 322) of the switched-capacitor circuit. In this case, the sensing at block 506 may entail closing the first and second switches for a first phase and opening the third and fourth switches for the first phase. For certain aspects, the sensing at block 506 involves closing the third and fourth switches for a second phase and opening the first and second switches for the second phase.

According to certain aspects, the sensing at block 506 includes continuously sensing the differential voltage during the operation of the switched-mode power supply circuit.

### Example Full Duty Mode Cfly Balancing

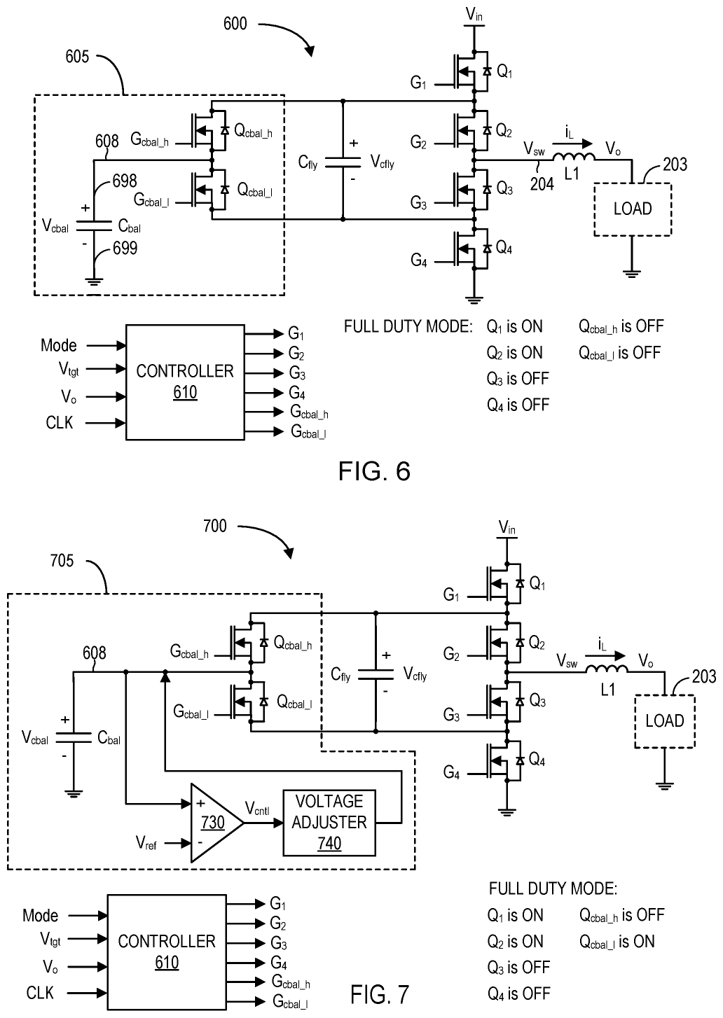

FIG. 6 is a schematic diagram of an example three-level buck converter 600, having similar components, circuit topology, and operation as the adaptive combination power supply circuit 200 of FIG. 2, such as transistors Q1-Q4, the flying capacitive element C_{fly}, the inductive element L1, and the load 203. As described above, the buck converter 600 receives an input voltage Vᵢₙ and generates an output voltage Vₒ based on a target voltage V_{tgt} serving as a target for the output voltage Vₒ. That is, the buck converter 600 controls or regulates the output voltage Vₒ such that the output voltage Vₒ is substantially the same as the target voltage V_{tgt}. The term “substantially the same” means that the voltages or parameters may not be exactly the same, but may deviate slightly due to non-ideal behavior (tolerances) of components (e.g., on-resistance of a switching device, equivalent series resistance of an inductor, etc.).

In particular, the buck converter 600 includes a set of switching devices (e.g., transistors Q₁, Q₂, Q₃, and Q₄) coupled in series (in that order) between an upper voltage rail (e.g., at input voltage Vᵢₙ, such as MID_CHG) and a lower voltage rail (e.g., at ground (Gnd) potential). Each of the switching devices may be configured as a transistor, such as a field-effect transistor (FET) or a bipolar junction transistor (BJT). For example, each of the switching devices may be configured as an n-channel metal-oxide-semiconductor (NMOS) FET, a p-channel metal-oxide-semiconductor (PMOS) FET, a pass gate, a transmission gate, or other type of switching device.

The set of switching devices (e.g., transistors Q₁, Q₂, Q₃, and Q₄) includes a set of control inputs (e.g., gates) configured to receive a set of control signals (e.g., G₁, G₂, G₃, and G₄, respectively). The set of control signals (G₁, G₂, G₃, and G₄) controls the closed (on) or open (off) states of the set of switching devices (Q₁, Q₂, Q₃, and Q₄, respectively). In the examples used herein, the control signal being at a logic high voltage causes the corresponding switching device to close, and being at a logic low voltage causes the corresponding switching device to open. However, it shall be understood that depending on the type of switching device, the control signal may be at a logic low voltage to close the corresponding switching device, and may be at a high logic voltage to open the corresponding switching device. Also, depending on the type of switching device, each of the control signals (e.g., G₁, G₂, G₃, and G₄) may be complementary logic signals.

The buck converter 600 is coupled to a voltage control circuit 605 for controlling the voltage V_{Cfly} across the flying capacitor C_{fly} during operation of the buck converter (e.g., control the voltage V_{Cfly} to a defined voltage of Vᵢₙ/2 (half the input voltage)). The voltage control circuit 605 includes upper and lower balancing switching devices (e.g., transistors Q_{cbal_h} and Q_{cbal_l}) coupled in series, the series combination being coupled in parallel with the flying capacitor C_{fly}. Similar to the switching devices (Q₁, Q₂, Q₃, and Q₄) in the buck converter, each of the balancing switching devices (Q_{cbal_h} and Q_{cbal_l}) may be configured as a transistor, such as a FET or derivative thereof (e.g., NMOS FET, PMOS FET, pass gate, transmission gate, etc.) or a BJT. The set of balancing switching devices (Q_{cbal_h} and Q_{cbal_l}) includes a set of control inputs (e.g., gates) configured to receive a set of control signals (e.g., G_{cbal_h} and G_{cbal_l}, respectively). Similar to the control signals for the switching devices (Q₁, Q₂, Q₃, and Q₄) in the buck converter 600, the set of control signals (G_{cbal_h} and G_{cbal_l}) in the voltage control circuit 605 controls the closed (on) and open (off) states of the set of balancing switching devices (Q_{cbal_h} and Q_{cbal_l}, respectively). Again, in this example, the control signal being a logic high voltage closes the corresponding switching device, and being a logic low voltage opens the corresponding switching device; but may be different as discussed with reference to the switching devices (Q₁, Q₂, Q₃, and Q₄) of the buck converter 600.

The voltage control circuit 605 further includes a balancing capacitor Chat coupled between a node 608 between the balancing switching devices (Q_{cbal_h} and Q_{cbal_l}) and the lower voltage rail (e.g., Gnd). That is, a first terminal 698 of the balancing capacitor C_{bal} is coupled to node 608, and a second terminal 699 of the balancing capacitor Chat is coupled to the lower voltage rail. The balancing capacitor C_{bal} may be configured to have substantially the same capacitance as the flying capacitor C_{fly}. This is done so that the voltage V_{Cfly} across the flying capacitor C_{fly} is substantially the same as the voltage V_{Cbal} across the balancing capacitor Chat (e.g., at substantially Vᵢₙ/2), when these capacitors are coupled in series between the upper voltage rail (Vᵢₙ) and the lower voltage rail (Gnd) (e.g., when transistors Q₁ and Q_{cbal_l} are turned on, as discussed in more detail further herein).

A controller 610 may be coupled to and configured to generate control signals for controlling operation of the buck converter 600 and the voltage control circuit 605. For example, the controller 610 may be configured to generate the set of control signals (e.g., G₁, G₂, G₃, G₄, G_{cbal_h}, and G_{cbal_l}) for the sets of switching devices (e.g., transistors Q₁, Q₂, Q₃, Q₄, Q_{cbal_h}, and Q_{cbal_l}, respectively), based on the target voltage V_{tgt}, the output voltage Vₒ, a clock signal CLK, and an operating mode signal. The operating mode signal configures the buck converter 600 to operate in one of several operational modes, such as a switching mode or a full duty mode, as discussed in more detail further herein. In the switching mode, the target voltage V_{tgt} may dictate whether the buck converter 600 should operate in a Vₒ/Vᵢₙ<0.5 switching mode or a Vₒ/Vᵢₙ>0.5 switching mode. For example, if the target voltage V_{tgt} is less than Vᵢₙ/2, the buck converter 600 may operate in the Vₒ/Vᵢₙ<0.5 switching mode, whereas if the target voltage V_{tgt} is greater than Vᵢₙ/2, the buck converter 600 may operate in the Vₒ/Vᵢₙ>0.5 switching mode. If the target voltage V_{tgt} is substantially at Vᵢₙ/2, the buck converter 600 may operate in either the Vₒ/Vᵢₙ<0.5 or Vₒ/Vᵢₙ>0.5 switching mode, or may switch between these switching modes to maintain the output voltage Vₒ at substantially Vᵢₙ/2.

The buck converter 600 is configured to generate a switching voltage V_{sw} at node 204 between certain switching devices (e.g., transistors Q₂ and Q₃). The buck converter 600 further includes an inductor L1 coupled between node 204 and the load 203. The load 203 is coupled between the inductor L1 and the lower voltage rail (Gnd). The output voltage Vₒ is generated across the load 203 due, at least in part, to an inductor current i_{L} flowing through the inductor L1 and into the load.

The derivative or slope of the inductor current i_{L} is a function of the voltage across the inductor L1 divided by its inductance L (e.g., dv/dt=(V_{sw}−Vₒ)/L). Accordingly, the buck converter 600 controls or regulates the output voltage Vₒ by controlling the switching voltage V_{sw}. When the switching voltage V_{sw} is higher than the output voltage Vₒ, the slope of the inductor current i_{L} is positive (increasing) to control the output voltage Vₒ. When the switching voltage V_{sw} is lower than the output voltage Vₒ, the slope of the inductor current i_{L} is negative (decreasing) to control the output voltage Vₒ. In switching mode, the switching voltage V_{sw} alternates, in response to the clock signal CLK, between being higher and lower than the output voltage Vₒ. In full duty mode, the switching voltage V_{sw} is set to be continuously at substantially yin so that the output voltage Vₒ is maintained substantially at the input voltage yin.

FIG. 6 illustrates the settings for the three-level buck converter 600 in full duty mode. In the full duty mode, the upper switching devices (e.g., transistors Q₁ and Q₂) are continuously closed (on), and the lower switching devices (e.g., transistors Q₃, Q₄) are continuously open (off). In certain implementations, the balancing switching devices (e.g., transistors Q_{cbal_h} and Q_{cbal_l}) are also open (off) during the full duty mode. There is no switching of the switching devices between closed and open in this mode. The input voltage Vᵢₙ is provided to the node 204 at which the switching voltage V_{sw} is produced via the closed switching devices (e.g., turned-on transistors Q₁ and Q₂). Thus, the switching voltage V_{sw} is substantially at the input voltage Vᵢₙ. The current i_{L} through the inductor L1 initially increases with a positive slope substantially equal to (Vᵢₙ−Vₒ)/L, until the current i_{L} levels off when the output voltage Vₒ is substantially the same as the input voltage Vᵢₙ. When this occurs, a constant supply of inductor current i_{L} is supplied to the load 203.

In this example configuration of the full duty mode, the flying and balancing capacitors C_{fly} and C_{bal} are floating. For example, the second terminal 210 of the flying capacitor C_{fly} coupled to the node 206 between transistors Q₃ and Q₄ is floating because these transistors are turned off, as well as transistor Q_{cbal_l}. Similarly, the first terminal 698 of the balancing capacitor C_{bal} coupled to node 608 is also floating because the balancing switching devices (e.g., transistors Q_{cbal_h} and Q_{cbal_l}) are both open. Because the capacitors C_{fly} and C_{bal} are floating, the voltages V_{Cfly} and V_{Cbal} across the capacitors C_{fly} and C_{bal} may significantly drift from the defined voltage of Vᵢₙ/2. When the buck converter 600 is then transitioned to operating in a switching mode, the differences in the voltages V_{Cfly} and V_{Cbal} across the capacitors C_{fly} and C_{bal} (an unbalanced situation) may cause damage to the circuit components, in particular to the balancing switching devices (Q_{cbal_l} and Q_{cbal_h}).

For example, if the voltage V_{Cfly} across the flying capacitor C_{fly} decreases significantly below Vᵢₙ/2 due to the floating of capacitor C_{fly}, the voltage at the lower terminal of the flying capacitor C_{fly} is higher than Vᵢₙ/2. Assuming the voltage V_{Cbal} across the balancing capacitor C_{bal} is at or lower than Vᵢₙ/2, when the operation of the buck converter 600 is changed from full duty mode to switching mode and the charging phase is commenced, the turning on of the lower balancing switching device (e.g., transistor Q_{cbal_l}) causes an excessive current (beyond the rating of the switching device) to flow through this switching device (Q_{cbal_l}) due to the voltage difference between the lower terminal of the flying capacitor C_{fly} and the upper terminal of the balancing capacitor C_{bal}. The excessive current can cause damage to the lower balancing switching device (Q_{cbal_l}).

Considering another example, the voltage V_{Cfly} across the flying capacitor C_{fly} may increase significantly above Vᵢₙ/2 due to the floating of capacitor C_{fly}. In this example, the voltage V_{Cbal} across the balancing capacitor C_{bal} may be at or lower than Vᵢₙ/2. Thus, there is a significant difference between the voltages V_{Cfly} and V_{Cbal} across the capacitors C_{fly} and C_{bal}, respectively. When the operation of the buck converter 600 is changed from full duty mode to a switching mode and the discharging phase is commenced, the turning on of transistors Q₄ and Q_{cbal_h} configures the capacitors C_{fly} and C_{bal} in parallel. The significant difference between the voltages V_{Cfly} and V_{Cbal} across the capacitors C_{fly} and C_{bal} produces an excessive current (beyond the rating of the switching device) through the upper balancing switching device (Q_{cbal_l}). The excessive current can cause damage to the upper balancing switching device (Q_{cbal_l}).

FIG. 7 is a schematic diagram of an example three-level buck converter 700 and a voltage control circuit 705, in accordance with certain aspects of the present disclosure. The buck converter 700 is configured to address the potential damage to the balancing switching devices (e.g., transistors Q_{cbal_h} and Q_{cbal_l}) when the operation of the buck converter 700 is switched from the full duty mode to another operational mode, such as a switching mode.

The buck converter 700 includes many of the same elements in the same configuration (as indicated by the same reference symbols and numbers) as those in FIG. 6. The voltage control circuit 705 is configured to control the voltage V_{Cbal} across the balancing capacitor C_{bal} such that the voltage V_{Cfly} across the flying capacitor C_{fly} is substantially at a defined voltage (e.g., Vᵢₙ/2), or at least within a voltage window of the defined voltage (e.g., ±10%, ±5%, ±2%, or ±1%). In this example, the voltage control circuit 705 includes the balancing switching devices (e.g., transistors Q_{cbal_h} and Q_{cbal_l}) and the balancing capacitor C_{bal} in the same configuration as in the voltage control circuit 605. The voltage control circuit 705 further includes at least one comparator 730 and a voltage adjuster 740. The comparator 730 compares the voltage V_{Cbal} across the balancing capacitor C_{bal} to a reference voltage V_{ref} (e.g., related or substantially equal to Vᵢₙ/2) and generates a control signal Vₑₙₜₗ based on the comparison. The voltage adjuster 740 adjusts the voltage V_{Cbal} across the balancing capacitor C_{bal} (e.g., the voltage at node 608) based on the control signal Venn.

Thus, during full duty mode, the controller 610 generates the set of control signals G₁, G₂, G₃, G₄, G_{cbal_h}, and G_{cbal_l} to turn on particular switching devices (e.g., transistors Q₁, Q₂, and Q_{cbal_l}), and turn off other switching devices (e.g., transistors Q₃, Q₄, and Q_{cbal_h}). The turning on of transistors Q₁ and Q₂ and turning off of transistors Q₃ and Q₄ configures the buck converter 700 in full duty mode, when the configuration of the switching devices does not change (e.g., changing to a holding phase or a discharging phase, as in a switching mode). The turning on of one balancing switching device (e.g., transistor Q_{cbal_l}), the turning off of another balancing switching device (e.g., transistor Q_{cbal_h}), and the comparator 730 and voltage adjuster 740 maintaining the voltage V_{Cbal} across the balancing capacitor C_{bal} to be substantially at or within a defined range of Vᵢₙ/2 keeps the voltages V_{Cfly} and V_{Cbal} across capacitors C_{fly} and C_{bal} balanced (e.g., substantially the same). Thus, when the buck converter 700 subsequently transitions to operate in a switching mode, there is no excessive current flow through the balancing switching devices (Q_{cbal_h} and Q_{cbal_l}) because the voltages V_{Cfly} and V_{Cbal} across capacitors C_{fly} and C_{bal} are substantially equal.

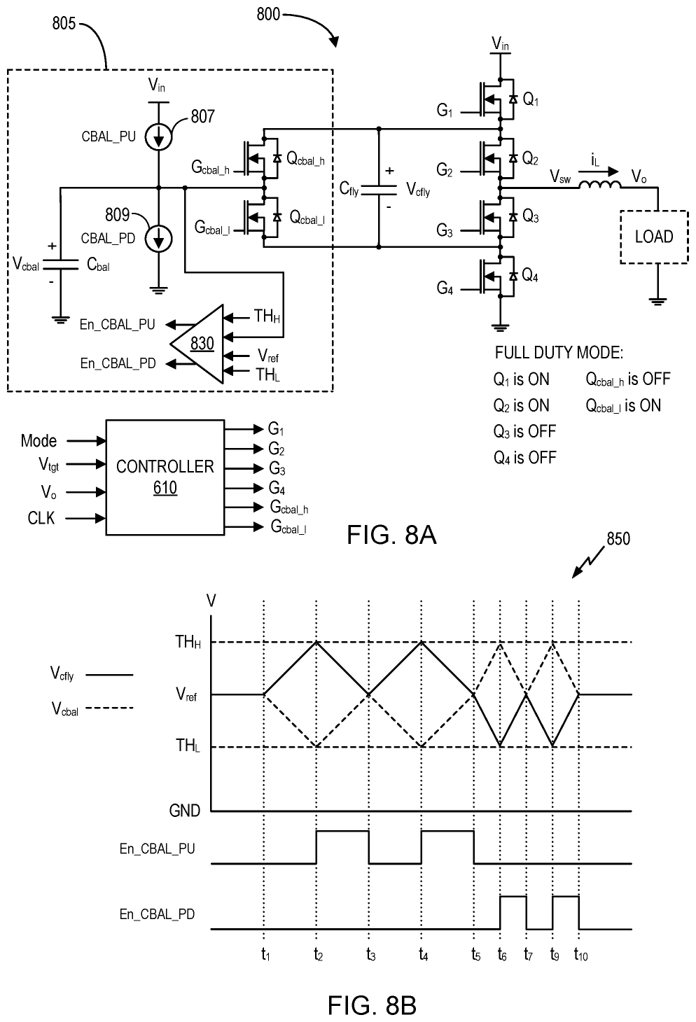

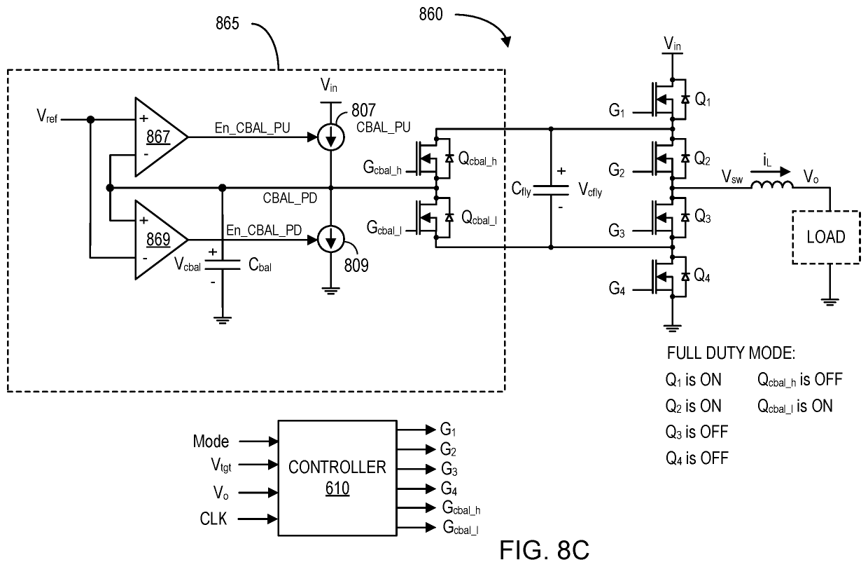

FIG. 8A is a schematic diagram of an example three-level buck converter 800 and an example voltage control circuit 805, implementing the voltage control circuit 705 of FIG. 7, in accordance with certain aspects of the present disclosure. Similar to buck converter 700, the buck converter 800 is configured to address the potential damage of the switching devices (e.g., transistors Q_{cbal_h} and Q_{cbal_l}) when the operation of the buck converter is changed from the full duty mode to another operational mode, such as switching mode. In particular, the buck converter 800 and voltage control circuit 805 includes many of the same elements in the same configuration (as indicated by the same reference symbols and numbers) as those in FIG. 7.

For example, the voltage control circuit 805 includes the balancing switching devices (e.g., transistors Q_{cbal_h} and Q_{cbal_l}) and balancing capacitor C_{bal} in the same configuration as in the voltage control circuit 705. The voltage control circuit 805 further includes a comparator 830 (e.g., a hysteresis comparator) and a voltage adjuster including pull-up current source 807 (labeled “CBAL_PU”) and pull-down current source 809 (labeled “CBAL_PD”) coupled in series between the upper voltage rail (Vᵢₙ) and the lower voltage rail (Gnd) and coupled to the first terminal 698 of the balancing capacitor C_{bal} and the node 608 between the balancing switching devices.

The comparator 830 is configured to receive the voltage V_{Cbal} across the balancing capacitor C_{bal}, the reference voltage V_{ref} (related or substantially equal to Vᵢₙ/2), upper threshold TH_{H}, and a lower threshold TH_{L}. The comparator 830 is configured to generate control signals En_CBAL_PU and En_CBAL_PD based on the inputs V_{Cbal}, V_{ref}, TH_{H}, and TH_{L}. The control signals En_CBAL_PU and En_CBAL_PD enable and disable the pull-up current source CBAL_PU and the pull-down current source CBAL_PD, respectively. The operation of the voltage control circuit 805 is discussed in more detail below.

FIG. 8B is a timing diagram 850 of example operation of the buck converter 800 and the voltage control circuit 805 of FIG. 8A, in accordance with certain aspects of the present disclosure. The horizontal axis of the timing diagram 850 represents time. The vertical axis of the upper portion of the timing diagram 850 represents voltage with respect to ground (GND) for the voltage V_{Cfly} across the flying capacitor C_{fly} and the voltage V_{Cbal} across the balancing capacitor C_{bal}. The voltage V_{Cfly} is represented by a solid line, whereas the voltage V_{Cbal} is represented by a dashed line. The lower portion of the timing diagram 850 depicts the logic states of the control signals En_CBAL_PU and En_CBAL_PD.

The operation of the voltage control circuit 805 is as follows. At time t₁, the voltages V_{Cfly} and V_{Cbal} are balanced (e.g., substantially the same at V_{ref}). Accordingly, the comparator 830 keeps the control signals En_CBAL_PU and En_CBAL_PD deasserted (e.g., at logic low) to maintain the pull-up and pull-down current sources CBAL_PU and CBAL_PD disabled. As the voltages V_{Cfly} and V_{Cbal} are balanced at time t₁, a voltage adjustment is not performed.

At time t₂, the voltage V_{Cbal} across the balancing capacitor C_{bal} has decreased to the low threshold TH_{L}, and consequently, the voltage V_{Cfly} across the flying capacitor C_{fly} has increased to the high threshold TH_{H}, assuming the high and low thresholds are the same voltage magnitude away from V_{ref}. In response, at time t₂, the comparator 830 asserts the control signal En_CBAL_PU and maintains the control signal En_CBAL_PD deasserted. The asserted control signal En_CBAL_PU enables the pull-up current source CBAL_PU to charge (e.g., provide current flow to) the balancing capacitor C_{bal} in order to increase the voltage V_{Cbal} (and consequently decrease the voltage V_{Cfly}). At time t₃, the voltage V_{Cbal} has increased to substantially V_{ref}, thereby balancing the voltages V_{Cfly} and V_{Cbal}. In response, the comparator 830 deasserts the control signal En_CBAL_PU. If the voltage V_{Cbal} drifts back to TH_{L} at time t₄, the comparator 830 again asserts the control signal En_CBAL_PU to enable the pull-up current source CBAL_PU to bring the voltages V_{Cbal} and V_{Cfly} back to the balanced condition at substantially V_{ref} at time t₅.

At time t₆, the voltage V_{Cbal} across the balancing capacitor C_{bal} has increased to the high threshold TH_{H}, and consequently, the voltage V_{Cfly} across the flying capacitor C_{fly} has decreased to the low threshold TH_{L}, assuming the high and low thresholds are the same voltage magnitude away from V_{ref}. In response, at time t₆, the comparator 830 asserts the control signal En_CBAL_PD and maintains the control signal En_CBAL_PU deasserted. The asserted control signal En_CBAL_PD enables the pull-down current source CBAL_PD to discharge (e.g., sink current from) the balancing capacitor C_{bal} in order to decrease the voltage V_{Cbal}. At time t₇, the voltage V_{Cbal} has decreased to substantially V_{ref}, thereby balancing the voltages V_{Cfly} and V_{Cbal}. In response, the comparator 830 deasserts the control signal En_CBAL_PD. If the voltage V_{Cbal} drifts back to TH_{H} at time t₉, the comparator 830 again asserts the control signal En_CBAL_PD to enable the pull-down current source CBAL_PD to bring the voltages V_{Cbal} and V_{Cfly} back to the balanced condition at substantially V_{ref} at time t₁₀.

FIG. 8C is a schematic diagram of the example buck converter 700 of FIG. 7 and another example implementation of the voltage control circuit 705, in accordance with certain aspects of the present disclosure. In FIG. 8C, the voltage control circuit 865 includes two hysteresis comparators 867 and 869 that output the control signals En_CBAL_PU and En_CBAL_PD for controlling the pull-up and pull-down current sources CBAL_PU and CBAL_PD, respectively. The hysteresis comparator 867 has a positive terminal coupled to the V_{ref} node and a negative terminal coupled to the upper terminal of the balancing capacitor C_{bal} (e.g., node 608). In this manner, hysteresis comparator 867 asserts EN_CBAL_PU when the voltage V_{Cbal} falls below V_{ref}, with hysteresis. In contrast, the hysteresis comparator 869 has a negative terminal coupled to the V_{ref} node and a positive terminal coupled to the upper terminal of the balancing capacitor C_{bal} (e.g., node 608). In this manner, hysteresis comparator 869 asserts EN_CBAL_PD when the voltage V_{Cbal} rises above V_{ref}, with hysteresis. Accordingly, the two comparators 867, 869 for a hysteresis window around V_{ref} (e.g., Vᵢₙ/2) to monitor the voltage V_{Cbal}, adjust the voltage V_{Cbal}, and thereby control the voltage V_{Cfly} to rebalance the two voltages.

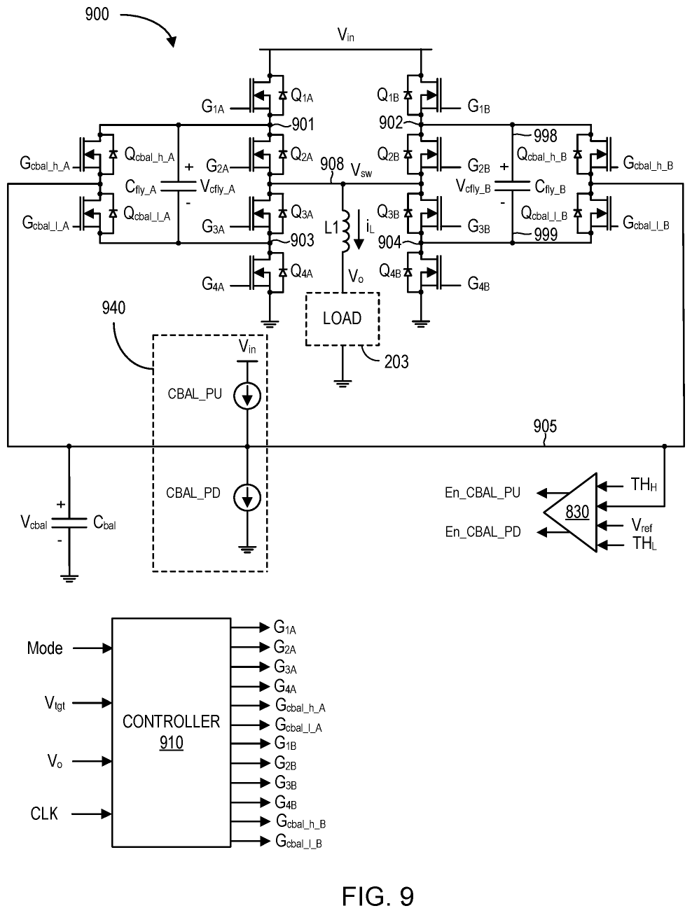

FIG. 9 is a schematic diagram of an example multi-branch three-level buck converter 900 and a voltage control circuit, in accordance with certain aspects of the present disclosure. In this example, the multi-branch buck converter 900 includes two switching branches “A” and “B” coupled to the inductor L1, which is coupled in series with the load 203. Each of the branches is configured similar to the single-branch buck converters described above.

That is, branch “A” of the buck converter 900 includes a set of switching devices (e.g., transistors Q_{1A}, Q_{2A}, Q_{3A}, and Q_{4A}) coupled in series (in that order) between an upper voltage rail (e.g., Vol) and a lower voltage rail (e.g., Gnd). The set of switching devices (Q_{1A}, Q_{2A}, Q_{3A}, and Q_{4A}) includes a set of control inputs (e.g., gates) configured to receive a set of control signals (e.g., G_{1A}, G_{2A}, G_{3A}, and G_{4A}, respectively). Branch “A” of the buck converter 900 further includes a flying capacitor C_{fly_A} coupled between: (1) a first node 901 between the first and second switching devices (e.g., transistors Q_{1A} and Q_{2A}) and (2) a second node 903 between the third and fourth switching devices (e.g., transistors Q_{3A} and Q_{4A}). Branch “A” of the buck converter 900 further includes another set of switching devices (e.g., transistors Q_{cbal_h_A} and Q_{cbal_l_A}) coupled in series, the series combination being coupled in parallel with the flying capacitor C_{fly_A}. The other set of switching devices (Q_{cbal_h_A} and Q_{cbal_l_A}) includes a set of control inputs (e.g., gates) configured to receive a set of control signals (e.g., G_{cbal_h_A} and G_{cbal_l_A}, respectively).

Branch “B” of the buck converter 900 includes a set of switching devices (e.g., transistors Q_{1B}, Q_{2B}, Q_{3B}, and Q_{4B}) coupled in series (in that order) between the upper voltage rail (Vᵢₙ) and the lower voltage rail (Gnd). The set of switching devices (Q_{1B}, Q_{2B}, Q_{3B}, and Q_{4B}) includes a set of control inputs (e.g., gates) configured to receive a set of control signals (e.g., G_{1B}, G_{2B}, G_{3B}, and G_{4B}, respectively). Branch “B” of the buck converter 900 further includes a flying capacitor C_{fly_B} coupled between: (1) a first node 902 between the first and second switching devices (e.g., transistors Q_{1B} and Q_{2B}) and (2) a second node 904 between the third and fourth switching devices (e.g., transistors Q_{3B} and Q_{4B}). Branch “B” of the buck converter 900 further includes another set of switching devices (e.g., transistors Q_{cbal_h_B} and Q_{cbal_l_B}) coupled in series, the series combination being coupled in parallel with the flying capacitor C_{fly} B. The other set of switching devices (Q_{cbal_h_B} and Q_{cbal_l_B}) includes a set of control inputs (e.g., gates) configured to receive a set of control signals (e.g., G_{cbal_h_B} and G_{cbal_l_B}, respectively).

Branches “A” and “B” of the buck converter 900 share a balancing capacitor C_{bal} coupled between a node 906 between the switching devices (Q_{cbal_h_A} and Q_{cbal_l_A}) in the balancing circuit of branch “A”—which is the same as the node between the switching devices (Q_{cbal_h_B} and Q_{cbal_l_B}) in the balancing circuit of branch “B”—and the lower voltage rail (e.g., Gnd). Branches “A” and “B” of the buck converter 900 are configured to generate a switching voltage V_{sw} at a node 908 coupled to certain switching devices of both branches (e.g., transistors Q_{2A}, Q_{3A}, Q_{2B}, and Q_{3B}). The inductor L1 is coupled between the node 908 and the load 203. The load 203 is coupled between the inductor L1 and the lower voltage rail (Gnd). The output voltage Vₒ is generated across the load 203 due, at least in part, to an inductor current i_{L} flowing through the inductor L1 and into the load.

Branches “A” and “B” also share a controller 910 configured to generate the set of control signals (e.g., G_{1A}, G_{2A}, G_{3A}, G_{4A}, G_{cbal_h_A}, and G_{cbal_l_A}) for the set of switching devices in branch “A” (e.g., transistors Q_{1A}, Q_{2A}, Q_{3A}, Q_{4A}, Q_{cbal_h_A}, and Q_{cbal_l_A}, respectively) and the set of control signals (e.g., G_{1B}, G_{2B}, G_{3B}, G_{4B}, G_{cbal_h} B, and G_{cbal_l_B}) for the set of switching devices in branch “B” (e.g., transistors Q_{1B}, Q_{2B}, Q_{3B}, Q_{4B}, Q_{cbal_h_B}, and Q_{cbal_l_B}, respectively), based on the target voltage V_{tgt}, the output voltage Vₒ, a clock signal CLK, and a mode signal. The mode signal configures the buck converter 900 to operate in one of several operational modes, such as a switching mode or a full duty mode, as previously discussed. In the switching mode, the target voltage V_{tgt} may dictate whether the buck converter 900 should operate in a Vₒ/Vᵢₙ<0.5 switching mode or a Vₒ/Vᵢₙ>0.5 switching mode.

Branches “A” and “B” of the buck converter 900 also share a portion of a voltage control circuit, which may be configured and operate similar to voltage control circuit 705 (or, more specifically, voltage control circuit 805 or 865) described above. For instance, the voltage control circuit may include a comparator 830 and a voltage adjuster 940 including pull-up current source CBAL_PU and pull-down current source CBAL_PD coupled in series between the upper voltage rail (Vᵢₙ) and the lower voltage rail (Gnd).

The comparator 830 is configured to receive the voltage V_{Cbal} across the shared balancing capacitor C_{bal}, the reference voltage V_{ref} (related or substantially equal to Vᵢₙ/2), an upper threshold TH_{H}, and a lower threshold TH_{L}. The comparator 830 is configured to generate control signals En_CBAL_PU and En_CBAL_PD based on the inputs V_{Cbal}, V_{ref}, TH_{H}, and TH_{L}. The control signals En_CBAL_PU and En_CBAL_PD enable and disable the pull-up current source CBAL_PU and the pull-down current source CBAL_PD, respectively. The operation of the voltage control circuit is the same as discussed with reference to voltage control circuit 805. As discussed, the voltage control circuit protects the switching devices Q_{cbal_h_A}, Q_{cbal_l_A}, Q_{cbal_h_B}, and Q_{cbal_l_B} from the branches “A” and “B” transitioning between full duty mode and switching mode.

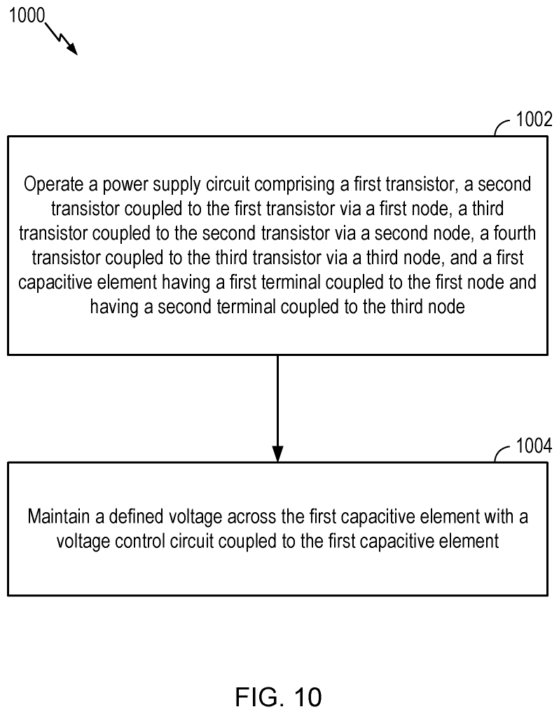

In some implementations, aspects of the present disclosure may be combined. For example, the switched-capacitor circuit 300 of FIG. 3 may be implemented in power supply circuits described herein, such as being added to the three-level buck converter 700, 800, 860, or 900 of FIG. 7, 8A, 8C, or 9, respectively. Similarly, the operations 500 of FIG. 5 may be combined with the operations 1000 in FIG. 10.

### Example Operations for Power Regulation with a Voltage Control Circuit

FIG. 10 is a flow diagram of example operations 1000 for regulating power, in accordance with certain aspects of the present disclosure. The operations 1000 may be performed by a power supply circuit (e.g., a three-level buck converter or an adaptive combination power supply circuit, such as the power supply circuit 200) and a voltage control circuit, such as the voltage control circuit 705, 805, or 865. The operations 1000 may be controlled by control logic, such as control logic 220, controller 610, or controller 910.

The operations 1000 may begin, at block 1002, by operating the power supply circuit. The power supply circuit generally includes a plurality of switching devices (e.g., transistors Q₁, Q₂, Q₃, and Q₄) coupled in series and a first capacitive element (e.g., capacitor C_{fly}). For example, the power supply circuit may include a first transistor (e.g., transistor Q₁), a second transistor (e.g., transistor Q₂) coupled to the first transistor via a first node, a third transistor (e.g., transistor Q₃) coupled to the second transistor via a second node (e.g., second node 204), and a fourth transistor (e.g., transistor Q₄) coupled to the third transistor via a third node. The first capacitive element has a first terminal (e.g., first terminal 208) coupled to the first node and has a second terminal (e.g., second terminal 210) coupled to the third node.

At block 1004, the voltage control circuit maintains a defined voltage (e.g., V_{ref}, which may be approximately Vᵢₙ/2) across the first capacitive element. The voltage control circuit is coupled to the first capacitive element. For certain aspects, the voltage control circuit may maintain the defined voltage at block 1004 at least when the third transistor and the fourth transistor are deactivated.

According to certain aspects, the first transistor is coupled between a power supply rail (e.g., Vᵢₙ) and the first node, and the fourth transistor is coupled between the third node and a reference potential node (e.g., electrical ground) for the power supply circuit. In this case, the defined voltage may be approximately half of a power supply voltage between the power supply rail and the reference potential node. For certain aspects, the operating at block 1002 may involve operating the power supply circuit in a full duty mode with the first and second transistors activated and with the third and fourth transistors deactivated. For example, the power supply circuit may be operated as a three-level buck converter in full duty mode.

According to certain aspects, the voltage control circuit may perform the maintaining at block 1004 by keeping a voltage (e.g., V_{Cfly}) across the first capacitive element between an upper threshold voltage (e.g., TH_{H}) and a lower threshold voltage (e.g., TH_{L}). In this case, the defined voltage may be between the upper threshold voltage and the lower threshold voltage.

According to certain aspects, the voltage control circuit includes a second capacitive element (e.g., capacitor C_{bal}). A capacitance of the second capacitive element may be substantially the same (e.g., within a tolerance of ±10%) as a capacitance of the first capacitive element. In this case, the maintaining at block 1004 may involve generating at least one control signal (e.g., Vent, EN_CBAL_PU, or EN_CBAL_PD) based on at least one comparison between a voltage (e.g., V_{Cbal}) across the second capacitive element and a reference voltage (e.g., V_{ref}) associated with the defined voltage and adjusting the voltage across the second capacitive element based on the at least one control signal. The reference voltage may equal the defined voltage. For certain aspects, adjusting the voltage across the second capacitive element comprises at least one of: activating a pull-up current source (e.g., CBAL_PU) coupled to the second capacitive element in response to the voltage across the second capacitive element being a first threshold voltage (e.g., V_{ref}−TH_{L}) below the reference voltage; or activating a pull-down current source (e.g., CBAL_PD) coupled to the second capacitive element in response to the voltage across the second capacitive element being a second threshold voltage (e.g., TH_{H}−V_{ref}) above the reference voltage. For certain aspects, the operating at block 1002 may entail activating the first and second transistors, deactivating the third and fourth transistors, decoupling the first terminal of the second capacitive element from the first terminal of the first capacitive element (e.g., using a first switching device (such as transistor Q_{cbal_h}) coupled between the first terminal of the first capacitive element and the first terminal of the second capacitive element), and coupling the first terminal of the second capacitive element to the second terminal of the first capacitive element (e.g., using a second switching device (such as transistor Q_{cbal_l}) coupled between the first terminal of the second capacitive element and the second terminal of the first capacitive element).

According to certain aspects, the switched-mode power supply circuit further includes another plurality of switching devices (e.g., transistors Q_{1B}, Q_{2B}, Q_{3B}, and Q_{4B}) coupled in series and a second capacitive element (e.g., C_{fly_B}) having a first terminal (e.g., first terminal 998) coupled to a third node (e.g., node 902) coupling a first pair (e.g., transistors Q_{1B} and Q_{2B}) of the other plurality of switching devices and having a second terminal (e.g., second terminal 999) coupled to a fourth node (e.g., node 904) coupling a second pair (e.g., transistors Q_{3B} and Q_{4B}) of the other plurality of switching devices. In this case, the operations 1000 may further entail the voltage control circuit maintaining the defined voltage across the second capacitive element. The voltage control circuit is further coupled to the second capacitive element.

### Example Power Supply Circuits

Certain aspects of the present disclosure are directed to a switched-mode power supply circuit. The switched-mode power supply circuit generally includes a plurality of transistors, a first capacitive element coupled to the plurality of transistors, and a switched-capacitor circuit coupled to the first capacitive element and configured to sense a differential voltage across the first capacitive element.

According to certain aspects, the switched-capacitor circuit includes a second capacitive element having a first terminal and a second terminal; a first switch coupled between the first terminal of the second capacitive element and a first terminal of the first capacitive element; a second switch coupled between the second terminal of the second capacitive element and a second terminal of the first capacitive element; a third switch coupled between the first terminal of the second capacitive element and a first output node of the switched-capacitor circuit; and a fourth switch coupled between the second terminal of the second capacitive element and a second output node of the switched-capacitor circuit. For certain aspects, the first and second switches are configured to be closed during a first phase and open during a second phase, and the third and fourth switches are configured to be open during the first phase and closed during the second phase. In this case, the switched-mode power supply circuit may further include control logic configured to control the first, second, third, and fourth switches such that the third switch closes after the fourth switch during the second phase. For certain aspects, the switched-mode power supply circuit further includes a third capacitive element having a first terminal coupled to the first output node of the switched-capacitor circuit and having a second terminal coupled to the second output node of the switched-capacitor circuit.

According to certain aspects, the switched-mode power supply circuit further includes a voltage divider circuit coupled between the first capacitive element and the switched-capacitor circuit.

According to certain aspects, the plurality of transistors includes a first transistor, a second transistor coupled to the first transistor via a first node, a third transistor coupled to the second transistor via a second node, and a fourth transistor coupled to the third transistor via a third node. In this case, the first capacitive element may have a first terminal coupled to the first node and a second terminal coupled to the third node. For certain aspects, a drain of the second transistor is coupled to a source of the first transistor, a drain of the third transistor is coupled to a source of the second transistor, and a drain of the fourth transistor is coupled to a source of the third transistor. In this case, the first, second, third, and fourth transistors may be implemented as NMOS transistors. For certain aspects, the first transistor is coupled to an input voltage node for the switched-mode power supply circuit. For certain aspects, the fourth transistor is coupled to a reference potential node for the switched-mode power supply circuit. For certain aspects, the switched-mode power supply circuit further includes an inductive element having a first terminal coupled to the second node and having a second terminal coupled to an output voltage node of the switched-mode power supply circuit. In this case, the switched-mode power supply circuit may further include a switch having a first terminal coupled to the first terminal of the inductive element and having a second terminal coupled to the second terminal of the inductive element. In this manner, the switched-mode power supply circuit may be configured as a three-level buck converter when the switch is open, but configured as a divide-by-two charge pump when the switch is closed.

Certain aspects of the present disclosure provide an apparatus for generating an output voltage across a load. The apparatus generally includes first, second, third, and fourth switching devices coupled in series between a first power rail and a second power rail, wherein the first power rail is configured to receive an input voltage; a first capacitor coupled between a first node between the first and second switching devices, and a second node between the third and fourth switching devices; an inductor coupled between a third node between the second and third switching devices and the load; a controller configured to operate the first, second, third, and fourth switching devices to generate the output voltage across the load; and a voltage control circuit configured to maintain a defined voltage across the first capacitor.

According to certain aspects, the defined voltage is substantially half of the input voltage.

According to certain aspects, the voltage control circuit comprises: fifth and sixth switching devices coupled in series across the first capacitor; and a second capacitor coupled between a fourth node between the fifth and sixth switching devices and the second power rail. For certain aspects, the controller, based on an operating mode, is configured to turn on the first and second switching devices, and turn off the third and fourth switching devices such that the output voltage is substantially the same as the input voltage. In this case, the controller, based on the operating mode, may be further configured to turn on the sixth switching device and turn off the fifth switching device, wherein the defined voltage across the first capacitor is produced by current flowing from the first power rail to the second power rail via the first switching device, the first capacitor, the sixth switching device, and the second capacitor. For certain aspects, the first capacitor has a capacitance substantially the same as a capacitance of the second capacitor such that the defined voltage is substantially half the input voltage.

According to certain aspects, the voltage control circuit further comprises: a comparator configured to generate a control signal based on a comparison of a voltage across the second capacitor and a reference voltage related to the defined voltage; and a voltage adjuster configured to adjust the voltage across the second capacitor based on the control signal. In this case, the voltage adjuster may include: (1) a first current source coupled between the first power rail and the fourth node; and (2) a second current source coupled between the fourth node and the second power rail.

Furthermore, the comparator may configured to: (1) turn on the first current source in response to the voltage across the second capacitor being a first defined threshold below the reference voltage; and (2) turn on the second current source in response to the voltage across the second capacitor being a second defined threshold above the reference voltage. The reference voltage may be substantially equal to the defined voltage.

According to certain aspects, the apparatus further includes fifth, sixth, seventh, and eighth switching devices coupled in series between the first power rail and the second power rail. In this case, the apparatus may also include a second capacitor coupled between a fourth node between the fifth and sixth switching devices, and a fifth node between the seventh and eighth devices, wherein the voltage control circuit is configured to maintain the defined voltage across the second capacitor.

Certain aspects of the present disclosure provide a power supply circuit. The power supply circuit generally includes a three-level buck converter circuit having a plurality of transistors coupled between a power supply rail and a reference potential node, having an inductive element coupled between the plurality of transistors and a load, and having a capacitive element coupled to the plurality of transistors. The power supply circuit also includes a voltage control circuit coupled to the capacitive element and configured to maintain a defined voltage across the capacitive element.

According to certain aspects, the power supply circuit further includes a switch coupled in parallel with the inductive element.

Certain aspects of the present disclosure provide a power supply circuit. The power supply circuit generally includes a first transistor; a second transistor coupled to the first transistor via a first node; a third transistor coupled to the second transistor via a second node; a fourth transistor coupled to the third transistor via a third node; a first capacitive element having a first terminal coupled to the first node and having a second terminal coupled to the third node; and a switched-capacitor circuit coupled to the first capacitive element and configured to sense a differential voltage across the first capacitive element.

According to certain aspects, the switched-capacitor circuit includes a second capacitive element having a first terminal and a second terminal; a first switch coupled between the first terminal of the first capacitive element and the first terminal of the second capacitive element; a second switch coupled between the second terminal of the first capacitive element and the second terminal of the second capacitive element; a third switch coupled between the first terminal of the second capacitive element and a first output node of the switched-capacitor circuit; and a fourth switch coupled between the second terminal of the second capacitive element and a second output node of the switched-capacitor circuit, wherein the first and second switches are configured to be closed during a first phase and open during a second phase and wherein the third and fourth switches are configured to be open during the first phase and closed during the second phase. For certain aspects, the power supply circuit further includes control logic configured to control the first, second, third, and fourth switches such that the third switch closes after the fourth switch during the second phase. For certain aspects, the power supply circuit further includes a third capacitive element having a first terminal coupled to the first output node of the switched-capacitor circuit and having a second terminal coupled to the second output node of the switched-capacitor circuit. For certain aspects, the power supply circuit further includes a voltage divider circuit coupled between the first capacitive element and the switched-capacitor circuit.

### CONCLUSION

Certain aspects of the present disclosure provide for sensing the flying capacitor voltage in an SMPS circuit, such as a 3-level buck converter, a Div2 charge pump, or an adaptive combination power supply circuit (also referred to as a combo-mode 3-level-buck/Div2 DC/DC converter). The flying capacitor voltage may be sensed in any operation mode, such as 3-level buck CCM, DCM, full on mode, skip mode, and Div2 mode in an adaptive combination power supply circuit. The flying capacitor voltage may be sensed continuously (e.g., all the time) regardless of the power FETs being in an on or off condition. Certain aspects of the present disclosure also have better switching noise immunity and eliminate the Cfly-voltage-detection blanking when the flying capacitor is switching. Furthermore, certain aspects of the present disclosure allow sensing the flying capacitor voltage with low-voltage devices, which saves silicon area when the DC/DC converter is used in some applications (e.g., high-voltage applications). Certain aspects of the present disclosure also provide for sensing the flying capacitor voltage with high accuracy, without requiring any trimming (e.g., of resistors).

Certain aspects of the present disclosure provide techniques and apparatus for maintaining the flying capacitor voltage within a voltage window around a reference voltage (e.g., Vᵢₙ/2) during full duty mode, to provide a seamless transition and avoid damaging components when changing operational modes from the full duty mode to a switching mode. This may be accomplished by comparing the voltage V_{Cbal} to the reference voltage and enabling a current source or a current sink in a bang-bang control scheme to adjust the voltage V_{Cbal}, thereby controlling the voltage V_{Cfly} to balance the two capacitor voltages.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

For example, means for operating a switched-mode power supply circuit may include control logic (e.g., the control logic 220, the controller 610, or the controller 910) and/or the drivers (e.g., the drivers 221-224). As another example, means for maintaining a defined voltage across the first capacitive element may include a voltage control circuit (e.g., the voltage control circuit 705 or 805).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation, and details of the methods and apparatus described above without departing from the scope of the claims.

What is claimed is:

1. A power supply circuit comprising:
a first transistor;
a second transistor coupled to the first transistor via a first node;
a third transistor coupled to the second transistor via a second node;
a fourth transistor coupled to the third transistor via a third node;
a first capacitive element having a first terminal coupled to the first node and having a second terminal coupled to the third node; and
a voltage control circuit coupled to the first capacitive element and configured to maintain a defined voltage across the first capacitive element.

2. The power supply circuit of claim 1, wherein the voltage control circuit comprises:
a second capacitive element selectively coupled to the first node and selectively coupled to the third node;
a pull-up current source coupled to the second capacitive element; and
a pull-down current source coupled to the second capacitive element.

3. The power supply circuit of claim 1, wherein:
the first transistor is coupled between a power supply rail and the first node;
the fourth transistor is coupled between the third node and a reference potential node; and
the defined voltage is approximately half of a power supply voltage between the power supply rail and the reference potential node.

4. The power supply circuit of claim 1, further comprising an inductive element coupled between the second node and a load for the power supply circuit, wherein the power supply circuit comprises a three-level buck converter configured in a full duty mode.

5. The power supply circuit of claim 1, wherein the voltage control circuit is configured to maintain the defined voltage across the first capacitive element by keeping a voltage across the first capacitive element between an upper threshold voltage and a lower threshold voltage, the defined voltage being between the upper threshold voltage and the lower threshold voltage.

6. The power supply circuit of claim 1, wherein the voltage control circuit comprises:
a second capacitive element having a first terminal and a second terminal;
a first switching device coupled between the first terminal of the first capacitive element and the first terminal of the second capacitive element; and
a second switching device coupled between the first terminal of the second capacitive element and the second terminal of the first capacitive element, wherein the second terminal of the second capacitive element is coupled to a reference potential node.

7. The power supply circuit of claim 6, wherein a capacitance of the second capacitive element is substantially equal to a capacitance of the first capacitive element.

8. The power supply circuit of claim 6, wherein the voltage control circuit further comprises:
at least one comparator configured to generate at least one control signal based on at least one comparison between a voltage across the second capacitive element and a reference voltage associated with the defined voltage; and
a voltage adjuster coupled to the at least one comparator and configured to adjust the voltage across the second capacitive element based on the at least one control signal.

9. The power supply circuit of claim 8, wherein the reference voltage is equal to the defined voltage.

10. The power supply circuit of claim 8, wherein the voltage adjuster comprises:
a first current source coupled between a power supply rail and the first terminal of the second capacitive element; and
a second current source coupled between the first terminal of the second capacitive element and the reference potential node.

11. The power supply circuit of claim 10, wherein the at least one comparator is configured to:
activate the first current source in response to the voltage across the second capacitive element being a first threshold voltage below the reference voltage; and
activate the second current source in response to the voltage across the second capacitive element being a second threshold voltage above the reference voltage.

12. The power supply circuit of claim 6, wherein the first switching device is open and the second switching device is closed during a full duty mode of the power supply circuit.

13. The power supply circuit of claim 1, further comprising:
a fifth transistor;
a sixth transistor coupled to the fifth transistor via a fourth node;
a seventh transistor coupled to the sixth transistor via a fifth node;
an eighth transistor coupled to the seventh transistor via a sixth node; and
a second capacitive element having a first terminal coupled to the fourth node and having a second terminal coupled to the sixth node, wherein the voltage control circuit is coupled to the second capacitive element and is further configured to maintain the defined voltage across the second capacitive element.

14. The power supply circuit of claim 1, further comprising a switched-capacitor circuit coupled to the first capacitive element and configured to sense a differential voltage across the first capacitive element.

15. The power supply circuit of claim 14, wherein the switched-capacitor circuit comprises:
a second capacitive element having a first terminal and a second terminal;
a first switch coupled between the first terminal of the second capacitive element and the first terminal of the first capacitive element;
a second switch coupled between the second terminal of the second capacitive element and the second terminal of the first capacitive element;
a third switch coupled between the first terminal of the second capacitive element and a first output node of the switched-capacitor circuit; and
a fourth switch coupled between the second terminal of the second capacitive element and a second output node of the switched-capacitor circuit.

16. The power supply circuit of claim 15, wherein the first and second switches are configured to be closed during a first phase and open during a second phase and wherein the third and fourth switches are configured to be open during the first phase and closed during the second phase.

17. The power supply circuit of claim 16, further comprising control logic configured to control the first, second, third, and fourth switches such that the third switch closes after the fourth switch during the second phase.

18. The power supply circuit of claim 15, further comprising a third capacitive element having a first terminal coupled to the first output node of the switched-capacitor circuit and having a second terminal coupled to the second output node of the switched-capacitor circuit.

19. The power supply circuit of claim 14, further comprising a voltage divider circuit coupled between the first capacitive element and the switched-capacitor circuit.

20. A method for regulating power, comprising:
operating a power supply circuit comprising:
a first transistor;
a second transistor coupled to the first transistor via a first node;
a third transistor coupled to the second transistor via a second node;
a fourth transistor coupled to the third transistor via a third node; and
a first capacitive element having a first terminal coupled to the first node and having a second terminal coupled to the third node; and
maintaining a defined voltage across the first capacitive element with a voltage control circuit coupled to the first capacitive element.

21. The method of claim 20, wherein:
the first transistor is coupled between a power supply rail and the first node;
the fourth transistor is coupled between the third node and a reference potential node; and
the defined voltage is approximately half of a power supply voltage between the power supply rail and the reference potential node.

22. The method of claim 21, wherein the operating comprises operating the power supply circuit in a full duty mode with the first and second transistors activated and with the third and fourth transistors deactivated.

23. The method of claim 20, wherein the maintaining comprises keeping a voltage across the first capacitive element between an upper threshold voltage and a lower threshold voltage, the defined voltage being between the upper threshold voltage and the lower threshold voltage.

24. The method of claim 20, wherein the voltage control circuit comprises a second capacitive element and wherein the maintaining comprises:
generating at least one control signal based on at least one comparison between a voltage across the second capacitive element and a reference voltage associated with the defined voltage; and
adjusting the voltage across the second capacitive element based on the at least one control signal.

25. The method of claim 24, wherein adjusting the voltage across the second capacitive element comprises at least one of:
activating a pull-up current source coupled to the second capacitive element in response to the voltage across the second capacitive element being a first threshold voltage below the reference voltage; or
activating a pull-down current source coupled to the second capacitive element in response to the voltage across the second capacitive element being a second threshold voltage above the reference voltage.

26. The method of claim 24, wherein the operating comprises operating the power supply circuit in a full duty mode by:
activating the first and second transistors;
deactivating the third and fourth transistors;
decoupling the first terminal of the second capacitive element from the first terminal of the first capacitive element; and
coupling the first terminal of the second capacitive element to the second terminal of the first capacitive element.

27. A power supply circuit comprising:
a three-level buck converter circuit having:
a plurality of transistors coupled between a power supply rail and a reference potential node;
an inductive element coupled between the plurality of transistors and a load; and
a capacitive element coupled to the plurality of transistors; and
a voltage control circuit coupled to the capacitive element and configured to maintain a defined voltage across the capacitive element.

28. The power supply circuit of claim 27, further comprising a switch coupled in parallel with the inductive element.

29. A power supply circuit comprising:
a first transistor;
a second transistor coupled to the first transistor via a first node;
a third transistor coupled to the second transistor via a second node;
a fourth transistor coupled to the third transistor via a third node;
a first capacitive element having a first terminal coupled to the first node and having a second terminal coupled to the third node; and
a switched-capacitor circuit coupled to the first capacitive element and configured to sense a differential voltage across the first capacitive element.

30. The power supply circuit of claim 29, wherein the switched-capacitor circuit comprises:
a second capacitive element having a first terminal and a second terminal;
a first switch coupled between the first terminal of the first capacitive element and the first terminal of the second capacitive element;
a second switch coupled between the second terminal of the first capacitive element and the second terminal of the second capacitive element;
a third switch coupled between the first terminal of the second capacitive element and a first output node of the switched-capacitor circuit; and
a fourth switch coupled between the second terminal of the second capacitive element and a second output node of the switched-capacitor circuit, wherein the first and second switches are configured to be closed during a first phase and open during a second phase and wherein the third and fourth switches are configured to be open during the first phase and closed during the second phase.
